(19) United States
(12) Patent Application Publication
(10) Pub. No.: US 2026/0023762 A1
(43) Pub. Date: Jan. 22, 2026

(54) GLOBALLY DISTRIBUTED OBJECT STORAGE, RETRIEVAL, AND MANAGEMENT

(71) Applicant: Tigris Data, Inc., Sunnyvale, CA (US)

(72) Inventors: Himank CHAUDHARY, Campbell, CA (US); Ovais TARIQ, Mountain View, CA (US)

(21) Appl. No.: 19/275,859

(22) Filed: Jul. 21, 2025

Related U.S. Application Data
(60) Provisional application No. 63/674,212, filed on Jul. 22, 2024.

(51) Int. Cl. G06F 16/29; G06F 16/27

(52) U.S. Cl. CPC G06F 16/29; G06F 16/27

(57) ABSTRACT

Disclosed herein are methods for efficient distribution of one or more objects. The method dynamically moves an object to a region on a network. The methods disclosed herein can be used to lower latency across a network and decrease the storage space lost to a system where each object is stored at every server.

### CROSS REFERENCE

This application claims the benefit of U.S. Provisional Application No. 63/674,212, filed Jul. 22, 2024, which is incorporated by reference herein in its entirety.

### SUMMARY

In one aspect, disclosed herein is a method for efficient distribution of one or more objects, comprising: receiving, from a computing device, a request to retrieve one or more objects; retrieving the one or more objects from a first region; analyzing a request pattern associated with the one or more objects; determining a second region based on the request pattern; and storing the one or more objects in the second region, wherein the second region is closer than the first region to the computing device.

In some embodiments, the request pattern comprises a plurality of requests comprising the request, wherein the plurality of requests are associated with a plurality of regions comprising the first region and the second region. In some embodiments, the first region comprises a region in which the one or more objects was created and/or first stored. In some embodiments, the first region comprises a region in which the one or more objects was stored prior to being stored in the second region. In some embodiments, the method further comprising removing the one or more objects from the first region. In some embodiments, the first region is closer than any other region of the plurality of regions to an initial request associated with the one or more objects. In some embodiments, the method further comprises storing the one or more objects in a third region. In some embodiments, a bucket associated with the one or more objects provides a unified entry point for accessing the plurality of regions. In some embodiments, the first region comprises a first cache and the second region comprises a second cache. In some embodiments, a first object of the one or more objects is associated with metadata. In some embodiments, the metadata comprises an identifier that is unique to the first object of the one or more objects. In some embodiments, the request comprises a request for the metadata associated with the first object. In some embodiments, the method further comprises providing a read request for the metadata to one or more servers. In some embodiments, the method further comprises receiving the metadata from at least one of the one or more servers in response to the read request. In some embodiments, the metadata comprises an indication of a set of regions where the first object is available. In some embodiments, the set of regions comprises the first region. In some embodiments, the one or more servers are located in the set of regions where the one or more objects are available. In some embodiments, the method further comprises modifying the metadata of the one or more objects once stored in the second region. In some embodiments, the modifying comprises adding the location of the second region to the metadata. In some embodiments, the first region comprises one location. In some embodiments, the second region comprises one location. In some embodiments, one or more locations of the one or more objects are stored in an object table. In some embodiments, a location of the first object is stored in an object table. In some embodiments, the metadata associated with the first object comprises the location of the first object. In some embodiments, the object table is accessible from the plurality of regions.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents and patent applications incorporated by reference contradict the disclosure contained in the specification, the specification is intended to supersede and/or take precedence over any such contradictory material.

### BRIEF DESCRIPTION OF THE DRAWINGS

The novel features of the inventive concepts are set forth with particularity in the appended claims. A better understanding of the features and advantages of the present inventive concepts will be obtained by reference to the following detailed description that sets forth illustrative embodiments, in which the principles of the inventive concepts are utilized, and the accompanying drawings (also “Figure” and “FIG.” herein), of which:

FIG. 1 shows a non-limiting example of a system for distribution of objects.

FIG. 2 shows a non-limiting example of a process for efficiently retrieving one or more objects.

FIG. 3 shows a non-limiting example of a system for globally distributing objects.

FIG. 4 shows a non-limiting example of the method disclosed herein for efficiently storing one or more objects.

FIG. 5 shows a non-limiting example of a computing device with one or more processors, memory, storage, and a network interface.

FIG. 6 shows a non-limiting example of a web/mobile application provision system providing browser-based and/or native mobile user interfaces.

FIG. 7 shows a non-limiting example of a cloud-based web/mobile application provision system comprising an elastically load balanced, auto-scaling web server and application server resources as well synchronously replicated databases.

### DETAILED DESCRIPTION

Accessing digital objects across a globally distributed network has several challenges. Distributed networks can be very large, and long distances between the origin of a request for an object and the location where the object is stored result in high latency. Such latency can tie up bandwidth on the network, slowing down request speeds. The greater distance also results in a higher chance of the object arriving corrupted or having lost information along the way. One potential solution would be to store all objects in all servers, thereby reducing latency and the risk of loss of data during its transmission—however, such a solution would result in extremely high costs to store large volumes of data that is largely redundant. Further, only a subset of the stored data would be accessed from locations geographically close to any given server in the network so the high cost of storing redundant copies of object would be wasted.

A low latency and storage efficient solution is disclosed herein that solves the issues described above by dynamically storing objects close to where they are accessed most often allowing the system to have low overall latency and minimizing wasteful levels of redundancy. Redundancy is important as it hedges against the loss of data as multiple sites possess that data.

### Systems

Disclosed herein are some embodiments for systems of global storage of one or more objects. In some embodiments, an object may include an image, video, a document (e.g., pdf, word doc, JSON document, etc.), application logs, application states, backups, machine learning models, or any random data. While some objects are listed above, these objects are exemplary and other types of objects may be used.

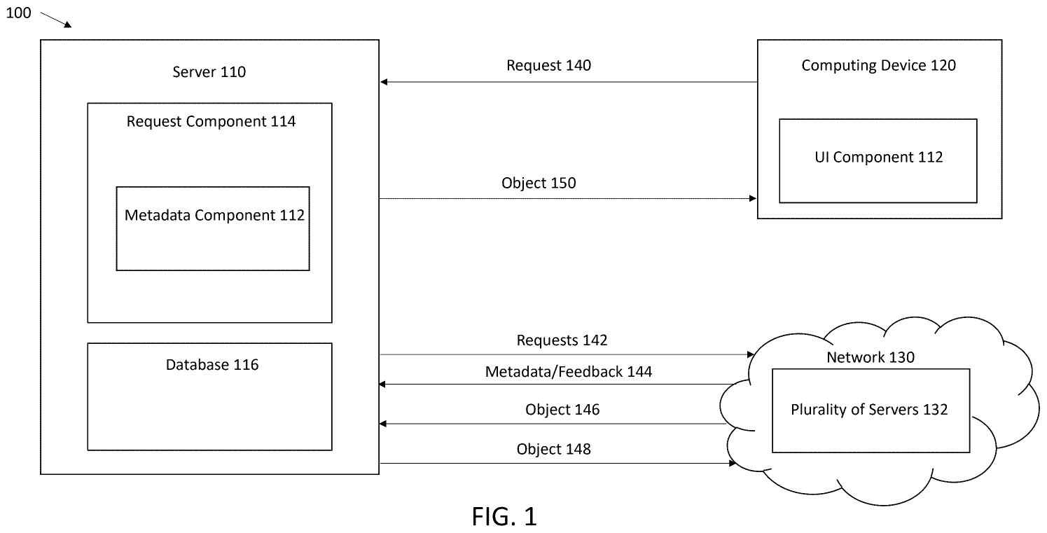

FIG. 1 depicts a non-limiting example of a computing system 100 for global storage of objects. In this depicted example, system 100 includes server 110, computing device 120, and network 130.

In this depicted example, server 110 includes a request component 114 comprising a metadata component 112, and database 116. In some embodiments, the server 110 may not include metadata component 112 and/or database 116. In those embodiments, the metadata component 112 and/or database 116 may be on one or more separate processing devices or carried out on the network 130 by one or more of the plurality of servers 132 of network 130. In some embodiments, the server 110 may be configured to receive requests to store one or more objects from one or more computing devices. The one or more computing devices may be located in a region of a plurality of regions. As described further below, the plurality of servers 132 of network 130 may be located across the plurality of regions. Further, the server 110 may be configured to, upon receiving the request to store an object, may be configured to provide the object and/or metadata of the object in a server of the plurality of servers 132. In some embodiments, the server of the plurality of servers 132 in which the object and/or the metadata of the object is stored is the server closest to the computing device (e.g., a server in the same region as the computing device, or a server in the region closest to the computing device if there is no server in the same region as the computing device.) The request to store the one or more objects, as well as the object and/or its metadata, may be provided by computing device 120 or another computing device. In some embodiments, an object table indicating the location of objects (e.g., which region the objects are in) is stored on the network 130. In some embodiments, the object table is included on each server of the plurality of servers 132, and may be updated if new objects are stored in network 130 or if objects are added to, removed from, or moved within the plurality of servers 132.

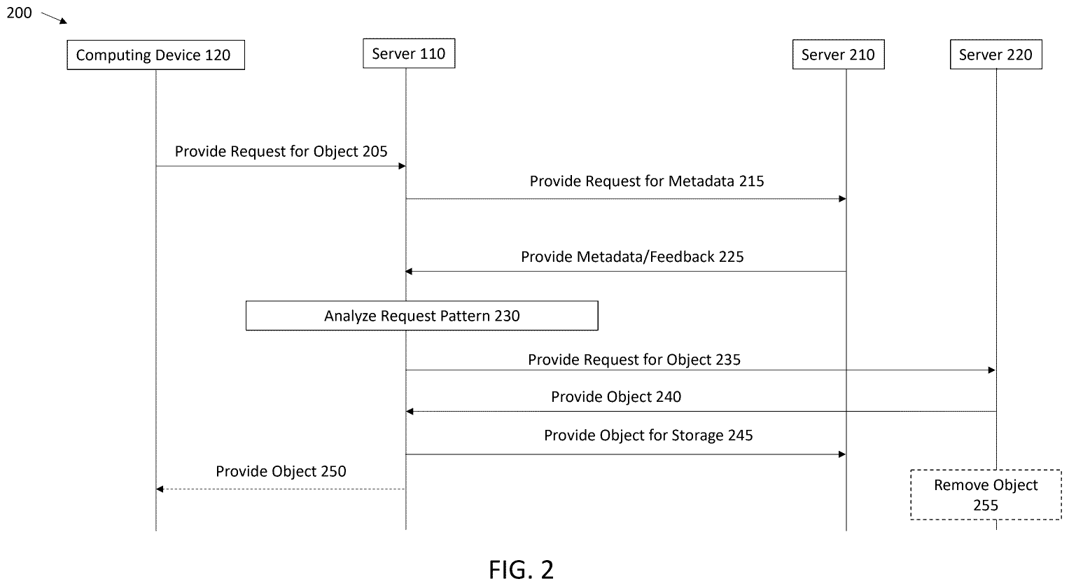

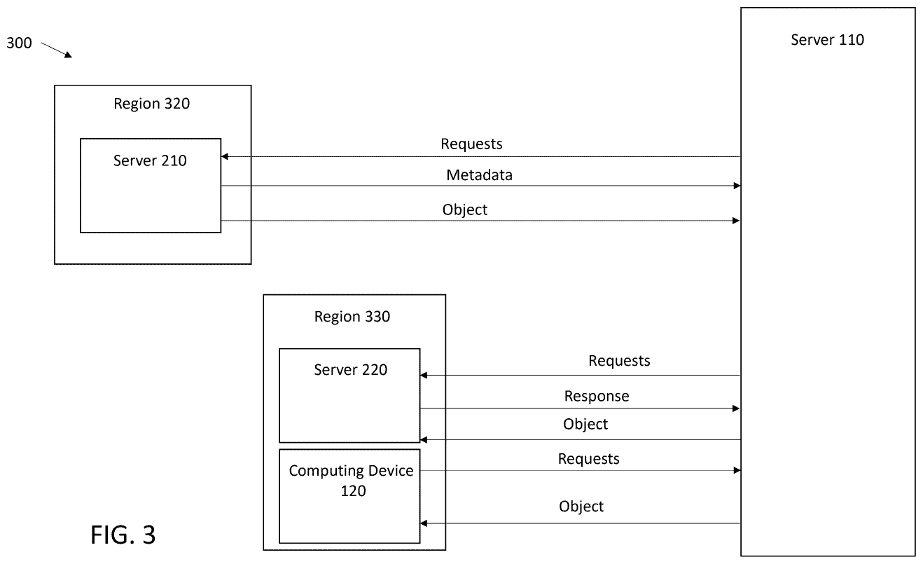

Computing device 120 may be configured to send a request 140 to server 110 for an object. In some embodiments, the request 140 comprises an identifier indicating the object. In some embodiments the request component 114 may be configured to receive the request 140. In some embodiments, the server 110 may be configured to send a request 142 for the object requested by the computing device 120 to the network 130 using request component 114. In this depicted embodiment, the server 110 provides a request 142 for the object to each server within the plurality of servers 132. As noted above, in some embodiments, the plurality of servers 132 may be located in a plurality of regions (e.g., a first server of the plurality of servers 132 may be located in a first region and a second server of the plurality of servers 132 may be located in a second region, as described further with respect to FIGS. 2-3). In some embodiments, the computing device 120 may be located within a region of the plurality of regions.

In some embodiments, each server of the plurality of servers 132 contains one or more objects and/or metadata for the one or more objects. In some embodiments, at least one server of the plurality of servers 132 contains the object indicated in the request 140. In some embodiments, the at least one server of the plurality of servers 132 includes a first server of the plurality of servers 132. In some embodiments, the first server includes the object of the request 140.

In some embodiments, the server 110 may send one or more requests 142 indicating the object indicated in request 140 (e.g., using the identifier of the object). In some embodiments, a first request of requests 142 is sent to a first server of plurality of servers 132 that is closest to the computing device 120 (e.g., as described above, a server in the same region as the computing device 120, or if no server is in the same region as the computing device 120, a server in the closest region to the computing device 120.) In some embodiments, in response to the first request of requests 142, the first server may provide a response. In embodiments, where the first server contains the object indicated in the first request of requests 142 and/or the metadata, the first server will provide metadata associated with the object. In embodiments, where the first server does not contain the object indicated in the first request of requests 142, the first server provides feedback indicating that the first server does not contain the object and/or its metadata, the first server references the object table as described above to determine the location of the object (e.g., the server of plurality of servers 132 on which the object is located). In those embodiments, the first server then provides feedback indicating the location of the object (e.g., a region in which the object is stored).

In some embodiments, the first server in the plurality of servers 132 is a server where the object was created or first stored. In some embodiments, the first server of the plurality of servers 132 is a server where the object was most recently stored. In some embodiments, the metadata 144 comprises information about where in the network the object indicated requests 140 and 142 are located in the network 130 (e.g., the first server, and in some embodiments, additional servers of the plurality of servers 132). In some embodiments, the metadata component 112 of request component 114 may analyze the metadata to determine where the object or copies of the object are located on the plurality of servers 132.

In some embodiments, based on the response of the first server (e.g., the metadata of the object indicated in the first request or the location of the object indicated in the first request), the server 110 sends a second request of requests 142 to one or more servers of the plurality of servers 132. In some embodiments, the server 110 provides the second request of requests 142 to one or more servers of plurality of servers 132 based on the response of the first server indicating that a region wherein the one or more servers of the plurality of servers 132 are located is where the one or more objects are stored. In some embodiments, the one or more servers of the plurality of servers 132 that are provided the second request is the first server. In some embodiments, the one or more servers of plurality of servers 132 that are provided the second request are different from the first server. In some embodiments, if a server of the one or more servers of the plurality of servers 132 is provided the second request of requests 142, but the server does not contain the object indicated by the second request of requests 142, the server may provide feedback indicating that it does not contain the object indicated by the request 142.

In some embodiments, a second server of the plurality of servers 132 that was provided the second request (e.g., the second server being of the one or more servers that receive the second request of requests 142) receives the request 142 and responds by providing object 146 (e.g., the object indicated in request 140 and requests 142) to the server 110. In some embodiments, the server 110 may send the object 150 (e.g., the object indicated in request 140 and requests 142) to the computing device 120 after receiving the object (e.g., as indicated by object 146). In some embodiments, the server 110 may then provide the object as object 148 to the server of the plurality of servers 132 that is closest to the computing device 120 (e.g., the first server of the plurality of servers 132) for storage (if the first server did not already store the object). In some embodiments, the object table may be updated in response to storing the object 148 in the first server. In some embodiments, the object may be removed from the one or more servers of the plurality of servers 132 in which the object was previously stored (e.g., the second server), conserving processing and storage resources within the network 130 through organization of objects within the network 130.

In this depicted embodiment, computing device 120 includes user interface (UI) component 112. In some embodiments, UI component comprises a user interface. In some embodiments, UI component comprises a graphical user interface. In some embodiments, UI component 112 comprises a programmatic user interface. In some embodiments, the user interface (UI) 112 is capable of receiving user input. In some embodiments, the user input may be text input, touch input, sound input, or another comparable input. In some embodiments, the user input may include one or more identifiers. In some embodiments, the one or more identifiers may include one or more identifiers of one or more objects.

In this depicted embodiment, computing device 120 may be configured to communicate with server 110. In this depicted embodiment, server 110 may be configured to communicate with computing device 120. In this depicted embodiment, computing device 120 may provide a request indicating an object (e.g., the object indicated in request 140 and request 142, associated with metadata 144, and provided as objects 146, 148, and 150) to the server 110. As described above, the server 110 may be configured to send a one or more requests 142 to the network 130 (e.g., the servers of the plurality of servers 132). For example, the server 110 may provide a request 142 to one or more of the plurality of servers 132 (e.g., the first server) that is closest to the computing device. If the object of the request 140 and 142 is not located on the geographically closest server of the plurality of servers 132, then the request component 114 may send another request 142 to a server associated with the location of the object of the request 140 and 142 (e.g., based on the response from the server closest to the computing device). The server of the plurality of servers 132 of network 130 that contains the object may then return the object 146 to the server 110. The object 148 (e.g., the same object as object 146) may then be sent by server 110 to the server in the plurality servers 132 that is closest to the computing device 120 for storage. The network 130 may then update the metadata to show the new location(s) of the object (e.g., in the object table) and send the updated metadata to the network 130.

In some embodiments, metadata may be stored on all servers of the plurality of servers 132. In some embodiments, metadata may be stored on more than one server of the plurality of servers. In some embodiments, the metadata of the object indicates by request 140 may be stored in one server of the plurality of servers. In some embodiments, the metadata may comprise information about an object's location in the network (e.g., which region an object is located in). In some embodiments, the object and/or copies of the object may be stored in multiple locations. In some embodiments, the metadata of the object may include an identifier. In some embodiments, the identifier may be unique to the object. In some embodiments, each object stored in the network 130 may be associated with a respective unique identifier.

A bucket is a storage mechanism in cloud computing similar to folders on a PC. Buckets contain objects which contain files. Buckets allow for object storage in a cloud computing system organized by geographical region. Buckets may span multiple regions, including the plurality of regions described herein, for advantageous storage of the objects described herein.

A single request may indicate multiple objects, or may be made up of multiple requests, such as a batch of requests. In some embodiments, multiple objects may be sent from one part of the system and other objects may be sent to others. In such an embodiment, server 110 may receive multiple objects 146 (e.g., from different servers) from the network 130 and server 110 may send corresponding objects 150 to the computing device 120. In some embodiments, there may be additional computing devices in addition to computing device 120 (e.g., more than one computing devices 120). In some embodiments, the more than one computing devices 120 may each send a request 140 to the server 110. In some embodiments the request component 114 may be configured to batch requests together before sending a request 142 comprising the multiple requests 140 to the network 130. In some embodiments, the server 110 may receive multiple objects 146 from the network 130. In some embodiments the server 110 may send objects 150 to multiple computing devices after having received them at the same time from the network 130. In some embodiments, the server 110 is configured to batch requests 140 from the computing devices 120 when they are within a given range of time from each other. In some embodiments, the server is configured to send requests 142 at a predetermined interval. In some embodiments, if no request 140 is received by the server 110 from the computing device 120 then the server 110 will not send a request 142 to the network 130.

As described above, in some embodiments the request 142 from server 110 comprises a request for metadata. In some embodiments the response from a server of the plurality of servers comprises feedback indicting the metadata is not available. In some embodiments the response from the server of the plurality of servers comprises metadata.

FIG. 2 depicts an example process 200 for storing and retrieving an object in a global network. In some embodiments the process may be performed by one or more processing devices. In the depicted embodiments, the process is performed by computing device 120, server 110, server 210, and server 220.

The process begins when server 110 receives a request for an object at step 205 from computing device 120. In some embodiments, the server 110 may provide a request for metadata at step 215 to the server closest to the computing device (e.g., the first server as described with respect to FIG. 1), which, in this example, is server 210. The server 210 and server 220 may be a part of a network (e.g., the network 130 described in FIG. 1, where the server 210 and server 220 would be a part of the plurality of servers 132).

The server 210, which, in this depicted example, does not contain the object, then responds with feedback indicating that the server 210 does not contain the object or its metadata at step 225. The response from server 210 further indicates a region and/or server within the region that contains the object. In embodiments where the server 210 did contain the object and its metadata, the server 210 would provide the metadata of the object to server 110 in response to the request at step 225. In embodiments where the server 210 did contain the object and its metadata, the server 210 would then provide the object in response to a second request from the server 110.

Upon receiving the metadata of the object from server 210, server 110 provides a request for the object at step 235 to server 220 based on the response from server 210 (e.g., indicating that server 210 does not contain the object, but that server 210 does contain the object or that the object is located in the region containing server 220 using the metadata component 116 of FIG. 1). The server 220 responds to the request for the object at step 240 by providing the object. Server 110 then may provide the object 250 to the computing device 120. Additionally, in this depicted embodiment, the server 110 further provides the object for storage in server 210 at step 245.

In the depicted example, the server 110 analyzes a request pattern 230 of the object in order to determine where the object should be stored. The analysis may comprise the use of a machine learning model. The analysis may comprise determining if by moving the object to one or more servers the network traffic may be improved. Such an analysis may comprise data such as longitudinal data indicating when the object was accessed, where the access request came from, total time from request of the object by a computing device 120 to delivery of the object to the computing device 120 by the server 110, dates of request, total requests at the time of the request for each server, total network latency, and any composite metric of the elements thereof. In some embodiments, the analysis may include determining a location of the computing device, and then comparing the location of the computing device to one or more servers (e.g., server 210, server 220, and other servers (e.g., the plurality of servers 132 of FIG. 1). Based on the analysis the object may be provided for storage to a server closest to the original request (e.g., server 210). Accordingly, in the depicted example, server 110 provides the object to server 210 for storage since server 210 is closer to the location of the computing device 120 (e.g., where the request for the object was provided from) than the server 220. In other embodiments with additional servers, a server different from server 210 may receive the object for storage based on the analysis (e.g., the server different from server 210 may be determined to be the server closest to where most requests for the object originate). Additionally, in this depicted example, the server 110 provides the object to computing device 120 at step 250 (e.g., in response to the original request at step 205). In some embodiments, based on the analysis of the request pattern, the object may be removed from one or more servers (e.g., at step 255 in this depicted example). For example, if it is determined that server 210 is closer to the computing device 120 than server 220, the server 110 may determine that, in addition to the object being stored in server 210, the object should be removed from server 220. If the server 110 makes that determination, the server 110 may provide a request to remove the object from server 220.

FIG. 3 depicts a process 300 for storing and retrieving an object in a global network. As described herein, objects may be located in regions (e.g., in a server within a region). A server 110 interacts with region 320 and region 330. In some embodiments, a request is received from region 330 (e.g., from computing device 120 to server 110). In some embodiments, the server 110 provides a request to server 220 in region 330 (e.g., the region containing computing device 120.) In the depicted example, server 220 and computing device 120 are located in region 330 which, for the purposes of this example, are geographically closer to each other than to region 320 and server 210. In the depicted example, the object is not present on server 220. Server 220 provides feedback to server 110 indicating that the object is not present on server 220. Server 210 of the geographically more distant region 320 does contain the object and provides the object and metadata pertaining to the object to server 110 in response to requests for the object from server 110. Because the object was copied to server 110 the metadata is updated to indicate the presence of the object on server 110. Server 110 provides the object to the computing device 120. In some embodiments, the object is further provided to and stored on server 220. In some embodiments, the object is stored in servers other than server 220 (e.g., based upon analysis of received requests regarding the object, as described further with respect to FIG. 2). In some embodiments, other servers are sent a request for metadata and/or a request for an object. In some embodiments, there may be more servers than server 210 and server 220 in regions 320 and 330, respectively, and the regions 320 and 330 may be included in a plurality of regions that includes regions in addition to regions 320 and 330.

In some embodiments, servers 210 and 220 would be pinged by server 110. In some embodiments, the ping time of the servers 210 and 220 may partially determine the server in the which the metadata and object are stored in by server 110. In some embodiments, a server that is not the closest to the computing device may be provided a request due to lower ping time. Lower ping time may be due to network traffic at a server. A high ping time may mean the server is busy. By choosing a server based on ping time between two or more servers of varying distance to the computing device the system may balance its workload and optimize server response time across the network. This is especially true when network utilization is not uniform across all servers on the network.

In some embodiments each region has a location. In some embodiments each region has multiple locations. In some embodiments there may be more regions than depicted.

### Example Method for Global Distribution of One or More Objects

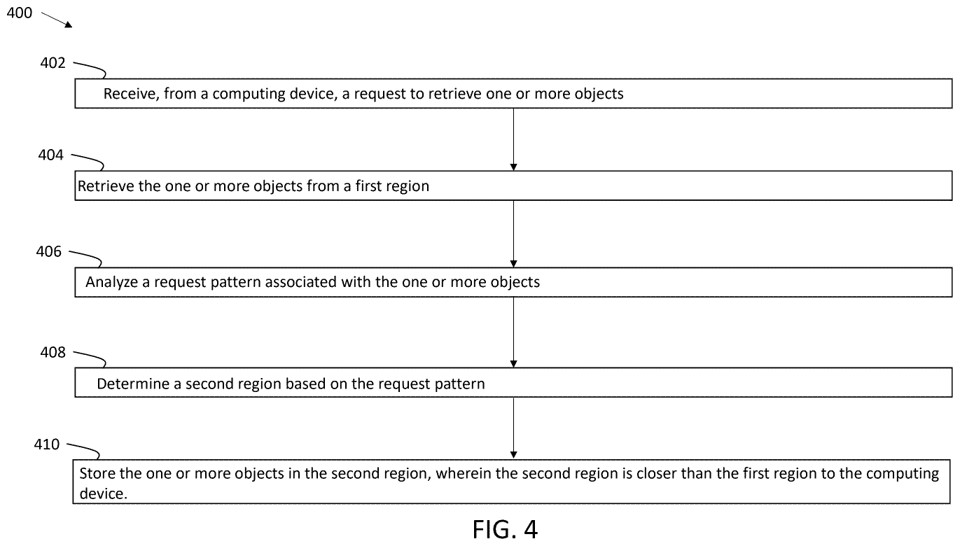

FIG. 4 depicts an example method 400 for global storage of an object (e.g., as described in FIGS. 1-3). In some embodiments, at least a portion of the method is performed by one or more processing devices (e.g., server 110 of FIGS. 1-3).

The method begins at step 402, where a request to retrieve one or more objects (e.g., request 140 of FIG. 1) is received. In some embodiments, the one or more objects (e.g., object 150 of FIG. 1) may be present on a server and sent in response to the request. In some embodiments, the one or more objects may be retrieved from a first region at step 404 (e.g., from a server in region 320 of FIG. 3). In some embodiments, the one or more objects may be retrieved from the first region in response to a request for the one or more objects from the first region. In some embodiments, the request for the one or more objects from the first region may be provided based on a response received from a second region. In some embodiments, the response from the second region may indicate a location of the object (e.g., that the object is located in the first region). In some embodiments, the response from the second region may be in response to a request to the first region, where the request to the first region is for the metadata of the object. In some embodiments, the first region and the second region are of a plurality of regions. In some embodiments, a plurality of servers may be located in the plurality of regions. In some embodiments, the first region may be where the object was created and/or first stored. In some embodiments, the first region is closer than any other region of the plurality of regions to the request to retrieve the one or more objects. In some embodiments, the first region may comprise a first server comprising a first cache and the second region may comprise a second server comprising a second cache. In some embodiments, a first object of the one or more objects is associated with metadata. In some embodiments, the metadata comprises an identifier that is unique to the first object. In some embodiments, the request to retrieve the one or more objects comprises a request for metadata associated with the first object. In some embodiments, the method further comprises providing one or more read requests for metadata. In some embodiments, the method further comprises receiving metadata in response to the one or more read requests. In some embodiments, the metadata comprises an indication of a set of regions where the first object is available.

A request pattern associated with the one or more objects is then analyzed in step 406. In some embodiments, a second region may be determined at step 408 based on the analysis of the request pattern. In some embodiments, analyzing the request pattern may comprise determining a server closest to a device from which the request to retrieve the one or more objects was received. In some embodiments, analyzing the request pattern may comprise determining where a majority of requests to retrieve the one or more objects are received from.

At step 410, the one or more objects are stored in the second region (e.g., within a server in the second region), which is closer to where the request to retrieve the one or more objects originated. In some embodiments, the one or more objects are removed from the first region (e.g., from a server in the first region that stores the one or more objects). In some embodiments, the one or more locations of the one or more objects are stored in an object table. In some embodiments, a location of the first object is stored in the object table. In some embodiments, the metadata of the first object comprises the location of the first object. In some embodiments, the method further comprises modifying the metadata of the one or more objects once stored in the second region. In some embodiments, modifying the metadata comprises adding the location of the second region to the metadata. In some embodiments, the object table is updated after the one or more objects are stored in the second region (e.g., to reflect that the one or more objects have been stored in the second region).

In some embodiments, servers as described herein may be an API server. In some embodiments the network comprises a plurality of metadata clusters. In some embodiments the metadata clusters operate in a distributed manner.

In some embodiments, servers as described herein may be a storage cluster. In some embodiments, the storage cluster may operate in a distributed manner.

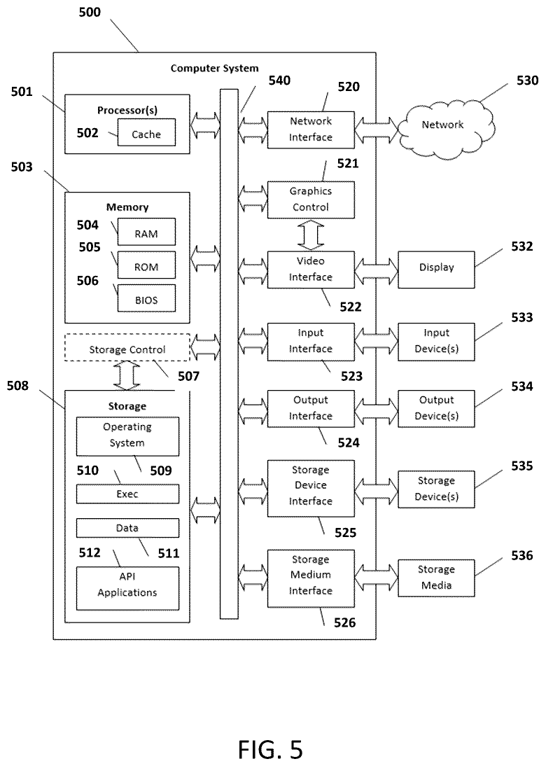

Referring to FIG. 5, a block diagram is shown depicting an exemplary machine that includes a computer system 500 (e.g., a processing or computing system) within which a set of instructions can execute for causing a device to perform or execute any one or more of the aspects and/or methodologies for static code scheduling of the present disclosure. The components in FIG. 5 are examples only and do not limit the scope of use or functionality of any hardware, software, embedded logic component, or a combination of two or more such components implementing particular embodiments.

Computer system 500 may include one or more processors 501, a memory 503, and a storage 508 that communicate with each other, and with other components, via a bus 540. The bus 540 may also link a display 532, one or more input devices 533 (which may, for example, include a keypad, a keyboard, a mouse, a stylus, etc.), one or more output devices 534, one or more storage devices 535, and various tangible storage media 536. All of these elements may interface directly or via one or more interfaces or adaptors to the bus 540. For instance, the various tangible storage media 536 can interface with the bus 540 via storage medium interface 526. Computer system 500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 500 includes one or more processor(s) 501 (e.g., central processing units (CPUs), general purpose graphics processing units (GPGPUs), or quantum processing units (QPUs)) that carry out functions. Processor(s) 501 optionally contains a cache memory unit 502 for temporary local storage of instructions, data, or computer addresses. Processor(s) 501 are configured to assist in execution of computer readable instructions. Computer system 500 may provide functionality for the components depicted in FIG. 5 as a result of the processor(s) 501 executing non-transitory, processor-executable instructions embodied in one or more tangible computer-readable storage media, such as memory 503, storage 508, storage devices 535, and/or storage medium 535. The computer-readable media may store software that implements particular embodiments, and processor(s) 501 may execute the software. Memory 503 may read the software from one or more other computer-readable media (such as mass storage device(s) 535, 536) or from one or more other sources through a suitable interface, such as network interface 520. The software may cause processor(s) 501 to carry out one or more processes or one or more steps of one or more processes described or illustrated herein. Carrying out such processes or steps may include defining data structures stored in memory 503 and modifying the data structures as directed by the software.

The memory 503 may include various components (e.g., machine readable media) including, but not limited to, a random access memory component (e.g., RAM 504) (e.g., static RAM (SRAM), dynamic RAM (DRAM), ferroelectric random access memory (FRAM), phase-change random access memory (PRAM), etc.), a read-only memory component (e.g., ROM 505), and any combinations thereof. ROM 505 may act to communicate data and instructions unidirectionally to processor(s) 501, and RAM 504 may act to communicate data and instructions bidirectionally with processor(s) 501. ROM 505 and RAM 504 may include any suitable tangible computer-readable media described below. In one example, a basic input/output system 506 (BIOS), including basic routines that help to transfer information between elements within computer system 500, such as during start-up, may be stored in the memory 503.

Fixed storage 508 is connected bidirectionally to processor(s) 501, optionally through storage control unit 507. Fixed storage 508 provides additional data storage capacity and may also include any suitable tangible computer-readable media described herein. Storage 508 may be used to store operating system 509, executable(s) 510, data 511, applications 512 (application programs), and the like. Storage 508 can also include an optical disk drive, a solid-state memory device (e.g., flash-based systems), or a combination of any of the above. Information in storage 508 may, in appropriate cases, be incorporated as virtual memory in memory 503.

In one example, storage device(s) 535 may be removably interfaced with computer system 500 (e.g., via an external port connector (not shown)) via a storage device interface 525. Particularly, storage device(s) 535 and an associated machine-readable medium may provide non-volatile and/or volatile storage of machine-readable instructions, data structures, program modules, and/or other data for the computer system 500. In one example, software may reside, completely or partially, within a machine-readable medium on storage device(s) 535. In another example, software may reside, completely or partially, within processor(s) 501.

Bus 540 connects a wide variety of subsystems. Herein, reference to a bus may encompass one or more digital signal lines serving a common function, where appropriate. Bus 540 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 500 may also include an input device 533. In one example, a user of computer system 500 may enter commands and/or other information into computer system 500 via input device(s) 533. Examples of an input device(s) 533 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 533 may be interfaced to bus 540 via any of a variety of input interfaces 523 (e.g., input interface 523) including, but not limited to, serial, parallel, game port, USB, FIREWIRE, THUNDERBOLT, or any combination of the above.

In particular embodiments, when computer system 500 is connected to network 530, computer system 500 may communicate with other devices, specifically mobile devices and enterprise systems, distributed computing systems, cloud storage systems, cloud computing systems, and the like, connected to network 530. Communications to and from computer system 500 may be sent through network interface 520. For example, network interface 520 may receive incoming communications (such as requests or responses from other devices) in the form of one or more packets (such as Internet Protocol (IP) packets) from network 530, and computer system 500 may store the incoming communications in memory 503 for processing. Computer system 500 may similarly store outgoing communications (such as requests or responses to other devices) in the form of one or more packets in memory 503 and communicated to network 530 from network interface 520. Processor(s) 501 may access these communication packets stored in memory 503 for processing.

Examples of the network interface 520 include, but are not limited to, a network interface card, a modem, and any combination thereof. Examples of a network 530 or network segment 530 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 530, may employ a wired and/or a wireless mode of communication. In general, any network topology may be used.

Information and data can be displayed through a display 532. Examples of a display 532 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 532 can interface to the processor(s) 501, memory 503, and fixed storage 508, as well as other devices, such as input device(s) 533, via the bus 540. The display 532 is linked to the bus 540 via a video interface 522, and transport of data between the display 532 and the bus 540 can be controlled via the graphics control 521. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 532, computer system 500 may include one or more other peripheral output devices 534 including, but not limited to, an audio speaker, a printer, a storage device, and any combinations thereof. Such peripheral output devices may be connected to the bus 540 via an output interface 524. Examples of an output interface 524 include, but are not limited to, a serial port, a parallel connection, a USB port, a FIREWIRE port, a THUNDERBOLT port, and any combinations thereof.

In addition or as an alternative, computer system 500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Sony® PS5®, Microsoft® Xbox 360®, Microsoft® Xbox One, Microsoft® Xbox Series X, Microsoft® Xbox Series S, Nintendo® Wii®, Nintendo® Wii U®, Nintendo® Switch™, and Ouya®.

Another aspect of the disclosure herein describes a non-transitory, computer-readable medium comprising executable instructions, wherein when a processor, when executing the executable instructions, performs a method as described herein.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, XML, and document-oriented database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

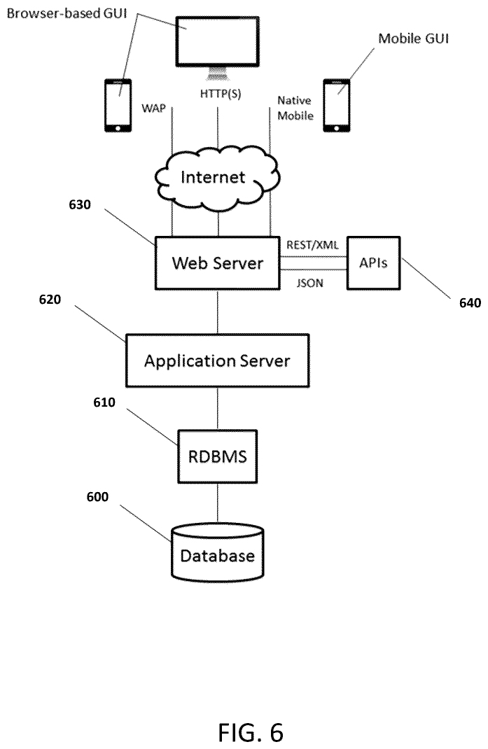

Referring to FIG. 6, in a particular embodiment, an application provision system comprises one or more databases 600 accessed by a relational database management system (RDBMS) 610. Suitable RDBMSs include Firebird, MySQL, PostgreSQL, SQLite, Oracle Database, Microsoft SQL Server, IBM DB2, IBM Informix, SAP Sybase, Teradata, and the like. In this embodiment, the application provision system further comprises one or more application servers 620 (such as Java servers, .NET servers, PHP servers, and the like) and one or more web servers 630 (such as Apache, IIS, GWS and the like). The web server(s) optionally expose one or more web services via app application programming interfaces (APIs) 640. Via a network, such as the Internet, the system provides browser-based and/or mobile native user interfaces.

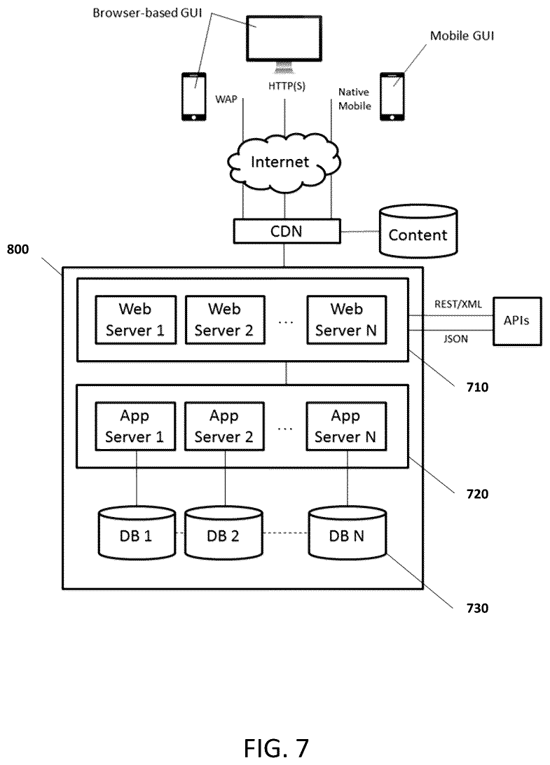

Referring to FIG. 7, in a particular embodiment, an application provision system alternatively has a distributed, cloud-based architecture 700 and comprises elastically load balanced, auto-scaling web server resources 710 and application server resources 720 as well synchronously replicated databases 730.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java™, JavaScript, Pascal, Object Pascal, Python™, Ruby, Rails, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of objects, metadata, or any combination thereof. In various embodiments, suitable databases include, by way of non-limiting examples, relational databases, non-relational databases, object-oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing based. In a particular embodiment, a database is a distributed database. In other embodiments, a database is based on one or more local computer storage devices.

### Data Transmission

The subject matter described herein, including methods and systems as described herein and may be configured to be performed in one or more facilities at one or more locations. Facility locations are not limited by country and include any country or territory. In some instances, one or more steps are performed in a different country than another step of the method. In some embodiments, one or more method steps involving a computer system are performed in a different country than another step of the methods provided herein. In some embodiments, data processing and storage are performed in a different country or location than one or more steps of the methods described herein. In some embodiments, one or more products or data are transferred from one or more of the facilities to one or more different facilities for analysis or further analysis. Data includes, but is not limited to, information regarding the stratification of a subject, and any data produced by the methods disclosed herein. In some embodiments of the methods and systems described herein, the subject information is compiled, and a subsequent data transmission step will transmit or store the subject information.

In some embodiments, any step of any method described herein is performed by a software program or module on a computer. In additional or further embodiments, data from any step of any method described herein is transferred to and from facilities located within the same or different countries, including analysis performed in one facility in a particular location and the data shipped to another location or directly to an individual in the same or a different country. In additional or further embodiments, data from any step of any method described herein is transferred to and/or received from a facility located within the same or different countries, including analysis of a data input, such as queries, objects, properties, types, filters, tables, or any combination thereof, performed in one facility in a particular location and corresponding data transmitted to another location.

### Business Methods Utilizing a Computer

The methods described herein may utilize one or more computers. The computer may be used for managing customer and subject information. The computer may include a monitor or other user interface for displaying data, results, billing information, marketing information (e.g., demographics), customer information, or sample information. The computer may also include means for data or information input. The computer may include a processing unit and fixed or removable media or a combination thereof. The computer may be accessed by a user in physical proximity to the computer, for example via a keyboard and/or mouse, or by a user that does not necessarily have access to the physical computer through a communication medium such as a modem, an internet connection, a telephone connection, or a wired or wireless communication signal carrier wave. In some cases, the computer may be connected to a server or other communication device for relaying information from a user to the computer or from the computer to a user. In some cases, the user may store data or information obtained from the computer through a communication medium on media, such as removable media. It is envisioned that data relating to the methods can be transmitted over such networks or connections for reception and/or review by a party.

The entity entering or reviewing information into a database for the purpose of one or more of the following: inventory tracking, order tracking, customer management, customer service, billing, and sales. Sample information may include, but is not limited to: customer name, unique customer identification, or any information suitable for storage in a database.

The database may be accessible by a user. Database access may take the form of electronic communication such as a computer or telephone. The database may be accessed through an intermediary such as a customer service representative, business representative, or consultant. The availability or degree of database access may change upon payment of a fee for products and services rendered or to be rendered.

### DEFINITIONS

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

### EXAMPLES

The following examples are included for illustrative purposes only and are not intended to limit the scope of the inventive concepts.

### Example 1: Routing a Request for an Object

FIG. 8 Depicts an example of a high-level deployment of API Servers demonstrating an embodiment of how, depending on the user's location, requests may be routed to the nearest server. In this example, the user requests are handled by the API server closest to the user. These API servers have the mapping of the metadata servers and storage locations in the global network. In this example, the API servers route to the closest metadata and storage servers using this mapping.

In this example, an object table stores metadata for all the objects of a bucket across all regions (such as 320 and 330 in FIG. 3). This metadata includes the object's location information. This object table is replicated to all the metadata servers globally. Allowing all the metadata servers to be aware of the object's location and have a global view of all the objects in the system.

When handling read operations, the API server may initially try to retrieve the object from the region where the request originates. It begins by requesting the object's metadata from the nearest metadata server. The metadata is returned if it is available. Otherwise, the object's location is retrieved from the object table. Using the information about the location of the object, the API server routes the request to the region where the object resides.

### Example 2: Data Distribution

Data distribution is a process that may run in the system to monitor the access pattern and optimize the access of these objects by moving objects close to the user. The distributor replicates the object closer to the user when it detects the access is happening at multiple locations, in this example, and once it detects that the object is no longer accessed from a specific location it removes the object from that location to optimize the storage. It is configured to ensure there are a minimum number of copies in the system and only extra copies are removed. The data distribution algorithm also may relocate the object in case the future requests are not made to the original object's region where the object was initially stored.

In the preceding examples, words such as “all”, and “global” may be used for exemplary purposes and should be understood to be meant as an optimal, non-binding, example of the systems and methods disclosed herein. In some embodiments, the system may have a limited view of the objects in the system. Global may further be understood within the context of the network the systems and methods have access to, in this example it is used in this manner and should not be construed as encompassing the entire physical world although in the case that the network accessible to the systems and methods does span the physical globe it may. The methods and systems described herein are not meant to be understood as limited to the surface of the planet as computing devices, servers and other components of the systems and methods described herein may exist in the atmosphere, in space, on the surface of extraterrestrial bodies (such as, but not limited to, the moon, a space station, another planet, etc.)

1. A method for distributing one or more objects, comprising:
a. receiving, from a computing device, a request to retrieve one or more objects;
b. retrieving the one or more objects from a first region;
c. analyzing a request pattern associated with the one or more objects;
d. determining a second region based on the request pattern; and
e. storing the one or more objects in the second region, wherein the second region is closer than the first region to the computing device.

2. The method of claim 1, wherein the request pattern comprises a plurality of requests comprising the request, wherein the plurality of requests is associated with a plurality of regions comprising the first region and the second region.

3. The method of claim 1, wherein the first region comprises a region in which the one or more objects was created and/or first stored.

4. The method of claim 1, wherein the first region comprises a region in which the one or more objects was stored prior to being stored in the second region.

5. The method of any one of claim 1, further comprising removing the one or more objects from the first region.

6. The method of claim 2, wherein the first region is closer than any other region of the plurality of regions to an initial request associated with the one or more objects.

7. (canceled)

8. The method of claim 2, wherein a bucket associated with the one or more objects provides a unified entry point for accessing the plurality of regions.

9. (canceled)

10. The method of claim 1, wherein a first object of the one or more objects is associated with metadata.

11. The method of claim 10, wherein the metadata comprises an identifier that is unique to the first object of the one or more objects.

12. The method of claim 10, wherein the request comprises a request for the metadata associated with the first object.

13. The method of claim 10, further comprising:
a. providing a read request for the metadata to one or more servers; and
b. receiving the metadata from at least one of the one or more servers in response to the read request, wherein the one or more servers are located in a set of regions where the one or more objects are available.

14. (canceled)

15. The method of claim 10, wherein the metadata comprises an indication of a set of regions where the first object is available.

16. (canceled)

17. (canceled)

18. The method of claim 10, further comprising modifying the metadata of the one or more objects once stored in the second region.

19. The method of claim 18, wherein the modifying comprises adding the location of the second region to the metadata.

20. (canceled)

21. (canceled)

22. (canceled)

23. (canceled)

24. (canceled)

25. (canceled)

26. A non-transitory computer-readable medium comprising executable instructions that, when executed by one or more processors, cause the one or more processors to perform a method, the method comprising:
a. receiving, from a computing device, a request to retrieve one or more objects;
b. retrieving the one or more objects from a first region;
c. analyzing a request pattern associated with the one or more objects;
d. determining a second region based on the request pattern; and
e. storing the one or more objects in the second region, wherein the second region is closer than the first region to the computing device.

27. A computer system comprising:
a memory comprising executable instructions; and
at least one processor configured to execute the instructions, wherein when the at least one processor executes the instructions, the at least one processor causes the system to:
a. receive, from a computing device, a request to retrieve one or more objects;
b. retrieve the one or more objects from a first region;
c. analyze a request pattern associated with the one or more objects;
d. determine a second region based on the request pattern; and
e. store the one or more objects in the second region, wherein the second region is closer than the first region to the computing device.

28. The system of claim 27, wherein the request pattern comprises a plurality of requests comprising the request, wherein the plurality of requests is associated with a plurality of regions comprising the first region and the second region.

29. The system of claim 27, wherein the first region comprises a region in which the one or more objects was created or first stored.

30. The system of claim 27, wherein the first region comprises a region in which the one or more objects was stored prior to being stored in the second region.

31. The system of claim 27, further comprising removing the one or more objects from the first region.
